(19) United States
(12) Patent Application Publication
(10) Pub. No.: US 2002/0114274 A1
(43) Pub. Date: Aug. 22, 2002

(54) Packet based network for supporting real time applications

(76) Inventors: James H. Sturges, Dallas, TX (US); Owen J. Palmer, Hermosa Beach, CA (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/956,602

(22) Filed: Sep. 19, 2001

Related U.S. Application Data
(60) Provisional application No. 60/233,944, filed on Sep. 19, 2000.

(51) Int. Cl. H04J 1/16; H04J 3/14

(52) U.S. Cl. 370/229; 370/231; 370/395.1

(57) ABSTRACT

A communication system supports packet based (e.g. IP) networking service with end-to-end quality of service packet delivery mechanisms. A local server, which resides on a customer's local area or wide area network, detects and marks packets for applications for different service levels will on the customer's network and prior to the packets being routed to an access or backbone network. The local server also coordinates with network services on a backbone network for enforcing access to the backbone network, coordinating setup of communication sessions and tracking lengths of sessions for billing purposes.

### RELATED PATENT APPLICATION

This application is related to provisional patent application No. 60/233,944, entitled “Packet Based Network for Supporting Real Time Applications” filed Sep. 19, 2000, from which priority is claimed and which is incorporated herein by reference.

### FIELD OF INVENTION

The invention pertains generally to communication networks, and particularly to packet-based networks providing broadband services with quality of service (QoS) guarantees.

### BACKGROUND OF THE INVENTION

Traditionally, voice and “data” have traditionally been carried over different networks. Circuit switched networks carried voice; packet switched networks carried data. However, with the large increase in the size and scope of packet networks, it has become desirable to seek ways to converge traditional voice and data traffic into a single network in order to reduce cost of operation and to provide more value-added and cost effective services. Despite the desirability of doing so, there are many problems to overcome in providing broadband network services that can support differentiated QoS using existing network infrastructures.

Circuit-switched networks provide connection-oriented networking services. A circuit switched network transports data over a physical path that is dedicated to a single connection between two end-points in the network for the duration of the connection. (The term “data” will refer to data in a generic sense, namely any type of information in digital format, such as information that represents text, still pictures or images, or digitized voice, audio, video or other type of analog signal.) A dedicated physical path with a fixed transfer rate or bandwidth is set up between to provide a guaranteed QoS. Thus, circuit-switched networks typically are used to provide communication services that are based in real time, such as telephone and teleconferencing.

Packet networks such as frame relay and Internet Protocol (IP) networks do not, generally speaking, dedicate physical paths to particular data flows. Rather, they provide a datagram service that routes small units of data using a destination address contained within each packet. Transporting data in packets allows the same data path to be shared among many users in the network. When a router receives a packet of data from another router, it stores the packet in a queue. The router then sequentially examines each packet and decides to what node the packet will be next sent based on its address. Reliability and QoS must be provided by other mechanisms. Without additional reliability mechanisms or services in place, packet based networks provide only a best effort level of service. Availability of resources (i.e. bandwidth) is not guaranteed, and thus no guarantee on minimum date transfers rates. Packets may be dropped or lost. Delay—referred to as latency—is caused by, for example, queuing of packets for transmission and other processing that may take place, and is not controlled. Latency will also vary, causing what is referred to as “jitter” or varying rates of delay. Many things, including varying queue lengths due to congestion and processing to reorder packets, cause jitter. The applications themselves may provide reliability, or the network may provide the service. Packet switched networks include frame relay and Internet Protocol (IP) based networks.

Although circuit switched networks by their nature provide guaranteed bandwidth, low latency and no jitter, they have several drawbacks. Circuit switched networks tend not to efficiently transport “bursty” services. Bursty services have high peak transfer rates as compared with their average data rates. In order to support high peak data transfer rates a physical channel with a data transfer rate commensurate with the peak rate must be dedicated. Thus, as the average data transfer rate is typically much lower than the peak rate, resources are inefficiently utilized. Circuit switched networks are also fundamentally more complex than packet based networks. In order to be used efficiently, circuit switched networks rely on multiple access methods to divide, in effect, a high bandwidth physical channel into many separate channels. These channels are switched to establish a dedicated physical path through the network. Time division multiplexing (TDM) is the most common method used. Furthermore, TDM is often operated on synchronous optical networks (SONET). Synchronously multiplexing data streams from many different sources into frames and switching the TDM channels to form paths for different communication sessions are, as compared to simple packet routing, complex tasks. Synchronous operation requires expensive and complex circuitry. Switches and media access equipment for TDM and SONET are therefore a good deal more expensive than asynchronous media access technologies conventionally used in packet networks, such as Ethernet.

Packet networks, in particular IP based networks, have become the focus of efforts to provide convergent services. IP is an open and widely adopted networking standard for routing packets over heterogeneous network media. Most applications—e.g. voice, video, teleconference, E-mail, file transfer—are supported on IP. Therefore, as IP is a widely adopted, open standard, many applications use IP and its companion protocols transmission control protocol (TCP) and user datagram protocol (UDP) to transport data end to end over heterogeneous networks. Several QoS mechanisms have been developed for supporting differentiated QoS guarantees across an IP network. These include differentiated services (DiffServ), reservation protocol (RSVP), and multi-protocol label switching (MPLS). However, the packet networks comprising the present Internet generally do not support these protocols. Furthermore, supporting QoS and the applications that require QoS over heterogeneous packet networks is still problematical. These protocols are designed primarily to be supported on autonomous IP networks. There is no support across the boundaries between different types of networks, such as between an IP network of a public carrier and a local or wide area network, or a virtual private network, of a corporate, institutional or government enterprise.

Physical links can provide differentiated QoS support for a packet network. For example, many carriers are now beginning to make extensive use of a packet network fabric called asynchronous transfer mode (ATM) to provide differentiated QoS in their core networks. ATM relies upon asynchronous time division multiplexing of cells of fixed length to provision virtual channels based on demand and resources. It is similar to a traditional packet based physical links such as Ethernet in that cells are routed or switched asynchronously based on a header in each cell. However, to provide a QoS, ATM requires creation of a virtual circuit for each data flow, which is an end-to-end connection that has defined end points and routes, but does not have bandwidth dedicated to it. The header defines the virtual circuit. Bandwidth is allocated on demand by the network as users have traffic to transmit, subject to the availability of resources and the class of service for the channel. Thus, different classes of service to meet a broad range of application needs can be provided.

ATM is becoming widely used as a network fabric, on which to converge service. IP traffic can be mapped to different virtual circuits to provide differentiated QoS. However, as compared to other network fabrics that can support IP, such as Ethernet and Gigabit Ethernet, ATM networks are considerably more costly to install and operate. ATM switches are much more complex and expensive than, for example, Ethernet switches. ATM networks therefore rarely extend to a customer, and almost never to a desktop. Rather, most customers choose to implement Ethernet as the network fabric for local area networks. Ethernet generally provides best efforts delivery of data frames, but many Ethernet switches support class of service (CoS) guarantees provided for under the IEEE 802.1 standard. However, if a carrier uses a packet backbone or core network to provide IP services to customers, it typically connects to customers through a TDM or ATM network in order to provide voice and other QoS services to the customer premise. A gateway must be provided to converge services onto a single network on a customer's premises, increasing equipment and operational cost and complexity.

### SUMMARY OF THE INVENTION

The invention overcomes one or more problems associated with the prior art to enable differentiated end-to-end packet networks with differentiated QoS for supporting real time, packet based applications according to service level agreements. By supporting end-to-end differentiated quality of service in the premises, access and backbone networks to enable real-time services such as voice and video, customers may consolidate all their traffic flows, such as voice, video and data, on a single access facility to their premises and obtain access to other networks in the most economical manner. Features and advantages of the invention, the scope of which is identified by the appended claims, will be apparent from a detailed description of a representative communications system utilizing the invention. Following is a brief summary of this system. This summary is not intended to define or limit the invention.

A representative example of a communication system utilizing the invention includes high bandwidth local access network and backbone networks supporting QoS mechanisms; a packet based (e.g. IP) networking service from the customer premises, over the local access and backbone networks; and a network server and a customer premises or local server.

The local server, which resides on a customer's local area or wide area network, detects and marks packets for applications requiring QoS prior to the packets being routed to an access or backbone network. The local server, upon detecting commencement of a packet flow requiring QoS, provides information on the duration of QoS sessions for billing purposes to the network server. In one embodiment, the local server uses a network management protocol such as SNMP (Simple Network Management Protocol) to communicate with routers and switches on the local area network, and remote monitoring capabilities of network elements such as routers and switches to identify data streams (e.g. transmission of data for voice over IP and other real time applications or services) requiring priority based on patterns of bits or fields in network and media frame headers of packets. Many network devices implement or support a suite of protocols referred to as RMON (Remote Monitoring), that can be used to set “traps” on network devices to trigger on fields in packet headers that are specific to the priority streams to be identified. SMON and CMON are new management protocols that may also be suited for high speed packet management on routers and switches. Preferably but not necessarily, these traps are set closest to a source of a data stream. The local server receives messages generated by the network devices and uses them to determine the beginning and end of the priority sessions, as well as for call admission control or other purposes. A router on the customer network, preferably one close to the source to ensure QoS through the customer network, marks packets for the data stream for priority service using, for example, a DiffServ DS byte on an IP packet. The DiffServ byte permits priority queuing of packets on routers on the local, access and backbone packet networks. Furthermore, a switch on the customer's network can also be used to mark media frames (e.g. Ethernet) according to an IEEE 802.1 standard to ensure QoS at the media level.

In addition to session registration and billing for QoS or priority sessions, the network server may include a call or session set up mechanism for mediating connections between different VoIP domains and to other voice networks. Interaction between the local server and network server enables translation of public addresses (e.g. DID telephone numbers), to which the network server has access, to private or dynamically assigned IP and MAC addresses, to which the local server has access, for mediating set up of sessions between domains.

Such a system has several advantages. Packets are identified and marked for priority on the customer's network, thereby enabling and enforcing end-to-end quality of services over both local and backbone networks. With local detecting and marking, the local server gives a customer with the ability to automatically provision the QoS of services based on applications and priorities established for those applications, as well as directory services and address management for address reuse within the customer's premises. Identifying the start and stop of a QoS guaranteed session allows charging based on sessions as opposed to per packet. Problems of having no gatekeeper between IP networks or between IP networks and other networks to provide signaling to set up QoS sessions are solved. Public DID or IP addresses can be translated to private IP and MAC addresses for call completion. Polices may be integrated across networks. Industry standard protocols and standard equipment may be utilized.

More features and details of the system are described in detail below in connection with the appended drawings.

### BRIEF DESCRIPTION OF THE DRAWINGS

FIG. 1 is a schematic representation of a representative system offering end-to-end differentiated QoS convergent communications services over packet networks, illustrating its interaction with other networks.

FIG. 2 is a schematic representation of a local area network of a customer and a packet backbone network.

FIG. 3 is a flow diagram of a network discovery process.

FIG. 4 is a flow diagram of a session set up process.

FIG. 5 is a flow diagram of a packet flow detection process.

### DESCRIPTION OF PREFERRED EMBODIMENTS

In the following description, like numbers refer to like parts.

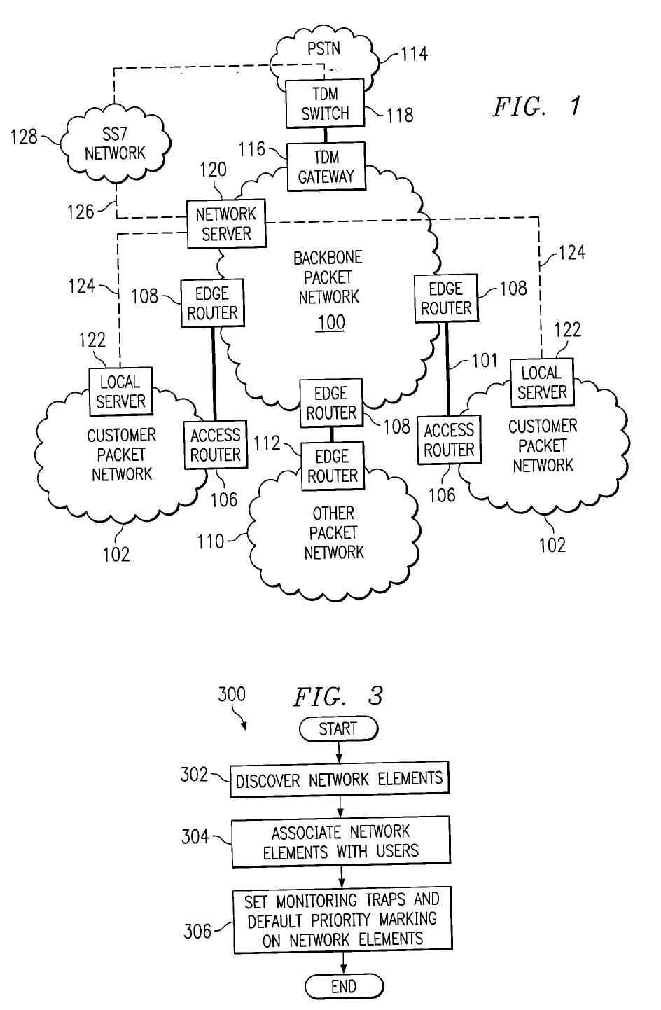

Referring to FIG. 1, backbone network 100 is a packet network. The packet network runs, in the presently preferred embodiment, network services based on the IP suite of protocols. These standards are very widely supported. The backbone network is of high enough capacity to support QoS guarantees to customers. Preferably, it includes a fiber physical layer utilizing dense wave division multiplexing (DWDM) equipment to connect to high-speed routers that only route packets. The backbone implements differentiated QoS, that can be based on service level agreements with customers, and mechanisms for billing for the differentiated QoS.

A local access network 101 connects customer network 102 to the backbone network. The customers networks are merely representative. There is no limit to the number or configuration of customer networks. The customer networks can be local or wide area networks running the same type of networking service as the backbone network, preferably IP. The local area networks preferably use a low cost networking medium of a speed sufficient to support expected traffic, such as Ethernet, Fast Ethernet or gigabit Ethernet. Each customer network includes an access router 106 on its premises that communicates with an edge router 108 on the backbone network 100. The backbone network connects to other service providers via a high-speed IP interface. The backbone network may connect to, for example packet network 110, which may provide access to the public Internet, through an edge router 108 on the backbone network and an edge router 112 on the other packet network. The backbone network may connect to the public switched telephone network 114 through a TDM gateway 116 and TDM switch 118.

In the preferred embodiment, the backbone network supports the Differentiated Services (DiffServ or DS) field and utilizes Multi-Protocol Label Switching (MPLS) as a traffic engineering tool to create Label-Switched Paths (LSP) for providing virtual private networks for customers, supporting specific applications (e.g. VoIP or video), and meeting specific QoS requirements. For example, a LSP can be created to reserve buffer space in queues to minimize packet loss, reserve capacity to meet bandwidth objectives, or minimize the number of hops to minimize transit delay through the backbone network. Resource ReSerVation Protocol (RSVP) can be used for dynamically creating LSPs. QoS in the backbone network relies on router QoS feature implementations and may rely on the following or similar mechanisms: OSPF extensions to define the routing network topology, Constraint Routing (CR) algorithms to route via non-shortest paths, RSVP-TE signaling to install MPLS labels MPLS in the backbone for traffic engineering, and DiffServ to assign flows into priority queues.

Network server 120 is representative of a centralized collection of services available on the backbone network to enable provision of differentiated quality of service and other enhanced services to meet service level agreements (SLAs) with customers. These services are most likely implemented in multiple client-server applications. The applications may be distributed across multiple computers and/or run in multiple instances. The network server may also work in coordination with other servers, such as policy servers and security servers.

The network server, which can be based on a soft switch platform, provides high-quality VoIP services in the backbone network, including interconnection between different VoIP domains and to other voice networks. The network server is a central point for collecting information for billing systems. The network server also is used in providing enhanced services in the backbone network that allow differentiated QoS and advanced service level agreements to customers.

The network server is used to implement, among other things, backbone management policies in order to provide enhanced differentiated QoS. However, these policies may instead be implemented operations support systems and coordinated with the network server. As will be described below, the network server collects information from local servers 122 for billing functions. In the preferred embodiment, the network server provides centralized control and signaling functions for two general types of traffic: session-based traffic (VoIP, other H.323 and T.120 traffic, non-native session-based traffic that could be delivered as sessions) and bursty, transaction-like traffic that can not be represented as a session (e.g., some types of web requests). For both the session-based and the non-session-based traffic, the network server preferably provides centralized functions for the entire network and communications to and from the local servers 122.

In a preferred embodiment, the network server mediates set up of QoS sessions, particularly VoIP calls, using standard protocols such as ITU H.323 and/or Session Initiation Protocol (SIP). The mediation functions can be implemented with, for example, a “softswitch.” The softswitch provides the functionality of a Class 4 or Class 5 switch, but has an abstract call coordinator that communicates through device servers to permit it to interface with other types of networks to set up service sessions. The device drivers might include those for communicating with H.323 gateways and gatekeepers for completion of VoIP, teleconference and other multimedia applications, and SS7 networks for completion of POTS (plain old telephone system) calls. A softswitch can be extended to include the additional functionality of communicating with local servers 122. The network server may also implement algorithms that allow constrained routing, account for the VoIP capacity utilization in the network, support call access control (CAC) and block calls when capacity is exceeded. CAC can be an important function of VoIP networks where the traditional PSTN-based call blocking must be substituted by the IP-specific mechanisms. Without CAC, when the number of calls in the IP network exceeds certain thresholds, most calls in progress will start displaying noticeable deterioration. To implement CAC, the local server sends a request to the network server to admit the next call. The network server responds to the local server with the appropriate CAC instructions. When an existing call terminates, the local server may also send a corresponding message to PNS.

The signaling and control associated with session set up between local server 122 and the network server 120 is logically represented by dashed lines 124. Dashed line 126 represents signaling between the network server 120 and the SS7 network 128 for call set up to the PSTN 114.

Local servers 122, each of which resides on one of the customer's local area or wide area network, enable and enforce end-to-end quality of services over the network. A broad objective of the local server is to provide a unified schema, stored in a centralized repository to search for relevant information quickly, for managing complex customer networks running sophisticated applications network. Thus, it provides two basic services: simplification of network access for end-users, and the capability to make relevant information available in a unified and cost effective format. Furthermore, use of a local server 122 at each customer network 102 allows architecture independence from routers and servers used by customers by classifying and marking packets entering the backbone network, registering the beginning and the end of traffic sessions, communicating this information to the network server for billing, and/or translating private or local addresses and public addresses.

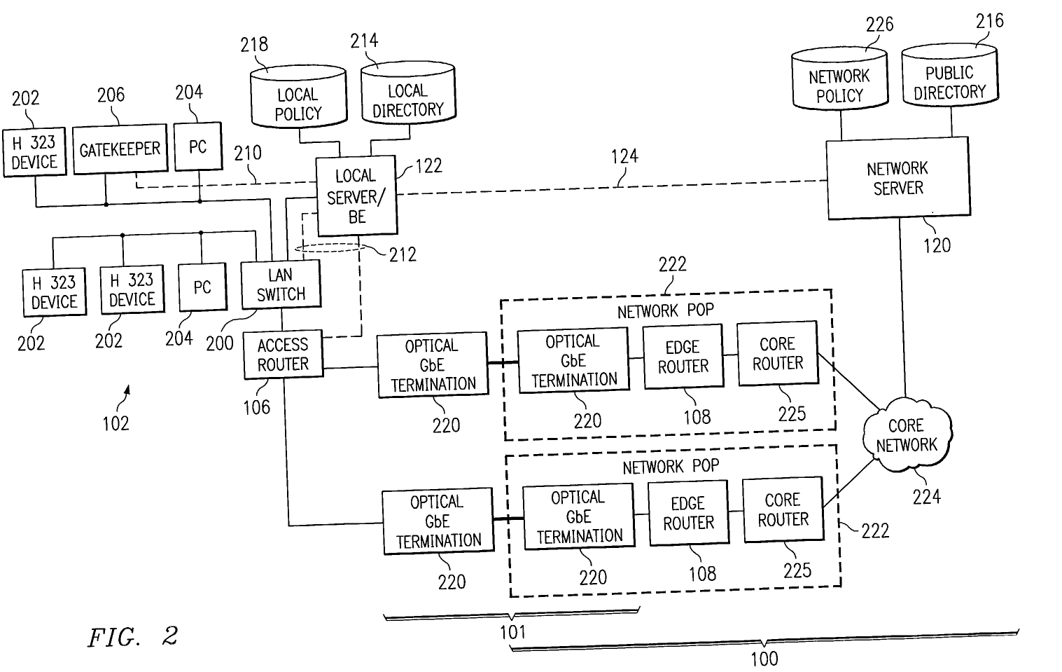

Referring now to FIG. 2, customer network 102 includes one or more local area networks connected together using multi-level switches and routers. The network might include servers for supporting end user applications and network capabilities such as domain name servers, policy servers, security servers and/or video servers. These have not been illustrated in the accompanying drawings. In the illustrated example of a customer network, a LAN switch 200 connects two segments. Connected to the segments are H.323 devices 202, computers 204, an H.323 gatekeeper server 206 and a H.323 gateway 208. H.323 is an International Telecommunications Union (ITU) standard for computers, equipment, and services for multimedia communication over networks. Therefore, the H.323 devices are intended to be merely representative of real time applications that may run on a local packet network. Such devices may rely on other protocols, such as SIP.

The H.323 standard is based on the Internet Engineering Task Force (IETF) Real-Time Protocol (RTP) and Real-Time Control Protocol (RTCP), with additional protocols for call signaling, and data and audiovisual communications. Users can connect with other people over the Internet and use varying products that support H.323, just as people using different makes and models of telephones can communicate over PSTN lines. H.323 devices may include IP telephones, computers, IP PBX, and other devices, including computers and gateways, that comply with H.323 protocol. H.323 computers and equipment may carry real-time video, audio, and data, or any combination of these elements. It does not provide a guaranteed quality of service. H.323 v3/H.225.0/Annex G defines how inter-domain VoIP communications are provided using the H.323 suite of protocols. Communications take place between so-called border elements (BE), which are software programs that can be collocated with H.323 entities, such as terminals, gateways and gatekeepers. All customer-based BE's communicate with a single network-based BE, which acts as a clearing house. Thus, local servers 122 can be used to communicate with the network server 120 for set up of sessions using H.323 protocol. The gatekeeper 206 translates LAN aliases for terminals and gateways to IP or IPX addresses. It also functions to manage bandwidth for H.323 calls. H.323 calls or sessions may also be routed through a gatekeeper so it can be controlled more effectively. The gatekeeper is logically separate from H.323 endpoints, though it may be incorporated a physical implementation of an H.323 gateway.

The local server 122 performs several functions. It maintains local QoS policies, which are logically represented by database 218, for managing the customer network to deliver differentiated QoS that the customer desires. The local server may also be used to access local databases, such as a local IP addressing system, to translate, in conjunction with the network server 120 or other server public IP addresses and traditional telephone numbers and private IP or MAC addresses. Sources of local access information are represented by local directory database 214, and public sources of address information are represented by public database 216.

The local server also identifies and classifies traffic, and, if necessary, marks its priority for a particular QoS treatment. Identification can be based on packet type, and information contained in packetheaders. Traffic flows can be further classified by other packet information, for example, source and destination IP addresses, TCP/UDP ports, and application layer information. The local server registers the beginning and the end of sessions associated with customer traffic serviced by the backbone network. An application or gatekeeper 206 may inform the local server 122 of a start and stop of a session, as indicted by dashed line 210 representing communication between the gatekeeper and local server. To avoid having to inspect every packet on the customer network, the local server may utilize a network management mechanism on one or more networking devices, such as LAN switch 200 or router 106, to detect a packet and/or media frames that require QoS classification and treatment, and that indicate the start and end of a session. As previously mentioned, the local network serve 122 communicates with the network server 120 to provide information about a session's start, end, QoS requirements, etc., and to block calls as directed by the network server. It can also provide QoS support for local traffic without involving the network server.

Managed network devices, particularly those that implement management functions in hardware (as opposed to software), permit the local server to monitor packets without a lot of additional overhead. A managed device can be any type of node residing on a network, including routers, switches, hubs, and servers. Dashed line 212 extending from local server 122 to various devices on the customer network 102, represents communication between the local server and the managed devices.

In a preferred embodiment, RMON/RMON2 or similar protocol may be utilized by the local server to collect from network nodes Ethernet or media access layer statistics associated with every network-layer conversation. In addition, information protocols in the network layer and above can also be collected. This protocol information can be associated with every network layer conversation. The local server may also use this information for user tracking, LAN segment tracking, and application profiling. Simple Network Management Protocol (SNMP), an application-layer protocol designed to facilitate the exchange of management information between network devices, is used for polling and threshold monitoring. RMON traps can be set for any Management Information Base (MIB) variable and reported to the local server either over the Ethernet side-band interface or through out-of-band (SLIP). A managed device can be any type of node residing on a network, including routers, switches, hubs, servers, et al. Polling is preferably minimized to avoid overhead, especially in relatively slow CPU and limited memory devices.

Interactive voice, video and multimedia applications require appropriate timing in data transmission and play back. RTP provides time stamping, sequence numbering, and other mechanisms to take care of timing and other issues. Through these mechanisms, RTP provides end-to-end transport for real-time data. RTP and RTCP packets are transmitted using UDP/IP service. RTP works in conjunction with RTCP to get feedback on quality of data transmission and information about participants in the on-going session.

RTP and RTCP packets are used, in the preferred embodiment, as triggers for RMON traps that signal the local server 122 for classifying sessions for priority, determining the start and stop of sessions and other purposes. RTCP, for example, includes a “bye” packet indicating conclusion of participation by the sender. A payload type identifier specifies the payload format as well as the encoding/compression schemes. At any given time of transmission, an RTP sender can only send one type of payload, although the payload type may change during transmission, for example, to adjust to network congestion. To set up an RTP session, the application defines a particular pair of destination transport addresses (one network address plus a pair of ports for RTP and RTCP). In a multimedia session, each medium is carried in a separate RTP session, with its own RTCP packets reporting the reception quality for that session. For example, audio and video would travel on separate RTP sessions, enabling a receiver to select whether or not to receive a particular medium. This permits the local server 122 to differentiate between audio and video streams.

Furthermore, this information can be used by the local server to adjust network conditions, or optimize applications for performance in the actual network conditions. RTCP, for example, sends quality feedback reports indicating performance. The local server can adjust its transmission based on the receiver report feedback via RTCP. The receivers can determine whether congestion is local, regional or global. Through such mechanisms, rate control can be accomplished in real-time in any zone on the network. In another example, each segment of a VoIP audio stream is preceded by an RTP header, and the resulting RTP message is placed in a UDP packet. The RTP header indicates the type of audio encoding that is used. The local server could cause a change to the encoding during a conference in reaction to network congestion or, for example, to accommodate low-bandwidth requirements of a new conference participant. Thus, RTCP can provide QoS monitoring and congestion control.

The access router 106, as previously mentioned, resides on the customer premises and communicates on the IP layer with the edge router in the backbone network. In the preferred embodiment, the access router may classify packets for routing based on source and destination IP addresses; source and destination TCP/UDP ports; ToS/DiffServ byte; the local server enabled marking of DiffServ or other field; IPSec header information for applications where IPSec starts at a host; and application layer information (e.g., HTTP application). It can also have a large number of software queues to queue classified packets with a high level of granularity, preferably using class-based queuing. This permits dealing with the customers on a per-user, per-location basis and enables customization of service level agreements (SLA).

The access router may mark, or re-mark, packets traffic as appropriate—for example, set or reset the DS byte. It may be necessary to mark packets again if the customer network utilizes coding for the priority marking that is different from the backbone network. The access router may also be used to police traffic on the ingress for compliance with policies (i.e., discard illegal packets and those that are received in excess of service level specifications. It can also be used to shape traffic on egress (i.e., smooth the flows to ensure that bandwidth is properly apportioned in the egress). IPSec tunnels may also be created by the access router that attempt to preserve the QoS classification related information of unencrypted packets. However, creation of IPSec tunnels depends on the customer implementation. IPSec may originate from a host (i.e. a computer, IP telephone, or other end device running an application), or it may originate in the access router. In the latter case, the IPSec encryption in the access router preserves the QoS classification related information that could have been derived from the unencrypted packet.

Each customer network preferably connects the backbone network 100 through an access network with very fast, relatively low cost links extending between the customer network's access router 106 and the backbone network's edge router 108. For example, a customer could lease one wavelength of a DWDM link. This service is analogous to leased fiber access except the customer will lease one or more wavelengths of the wavelengths available on the fiber. Alternately, wireless/optic air OC-48 interfaces to the customer could be provided. As indicated by optical Gbe termination equipment 220, the access network preferably runs gigabit Ethernet. For redundancy, the customer network connects to two, geographically spaced, network points of presence (POP) 222. This redundancy ensures that, if one connection is broken, another will remain available. Each network POP may service multiple customers. Each network POP connects to the core network 224, which is comprised of a plurality of core routers 225. For the most part, traffic flows on wavelengths directly connecting the edge routers. The backbone core routers provide alternative paths for redundancy and MPLS tunnels for edge-to-edge connection with little traffic. In this manner, hops, switching, and optical interfaces are minimized.

QoS mechanism requirements for edge routers 108 and core routers 225 are different. The edge routers process traffic arriving from a customer, while the core routers must be very fast. The edge routers classify packets based on ingress port, priority marking (e.g. DiffServ byte value) set by the access router 106, police traffic on ingress, shaping traffic on egress and creating MPLS tunnels. The priority marking is used between the access router and edge router to provide the signaling between customer network 102 and backbone network 100 that allows classifying traffic on the backbone network. DiffServ can also be used in the backbone network to define the priority queue for a specific packet. QoS requirements for core routers include forwarding packets based on the MPLS header, policing traffic on ingress (based on SLAs), using priority queues.

Network server 120 retains a central repository for network QoS policy, represented by database 226, preventing each local administrator, or even sophisticated users, from allocating bandwidth and priorities on an ad-hoc basis. The network server synchronizes local policy on customer networks with overall network policies to create guarantees to applications and their execution for end-to-end sessions traversing multiple, heterogeneous private and public networks. Thus, priority-based decisions are made on a globally optimized basis.

As previously alluded to, the network server also may act as a “clearing house” for application gatekeepers on local networks. For example, working with local server 122, it provides in a preferred embodiment address resolution, access authorization and usage reporting between administrative domains (e.g. the customer networks) for purposes of completing H.323 calls between administrative domains.

To better understand the functions of local server 122, please refer now to FIGS. 3, 4 and 5 in addition to FIG. 2. FIG. 3 illustrates a discovery and set up process 300 that occurs on customer network 102. At step 302, the local server 122 discovers elements of the customer network. At step 304, it associates the network elements with the users. It sets monitoring traps, such as RMON traps, and default priority markings on certain network devices, such as switches and routers at step 306. These traps and priority markings are a matter of local policy that is locally stored in representative database 218.

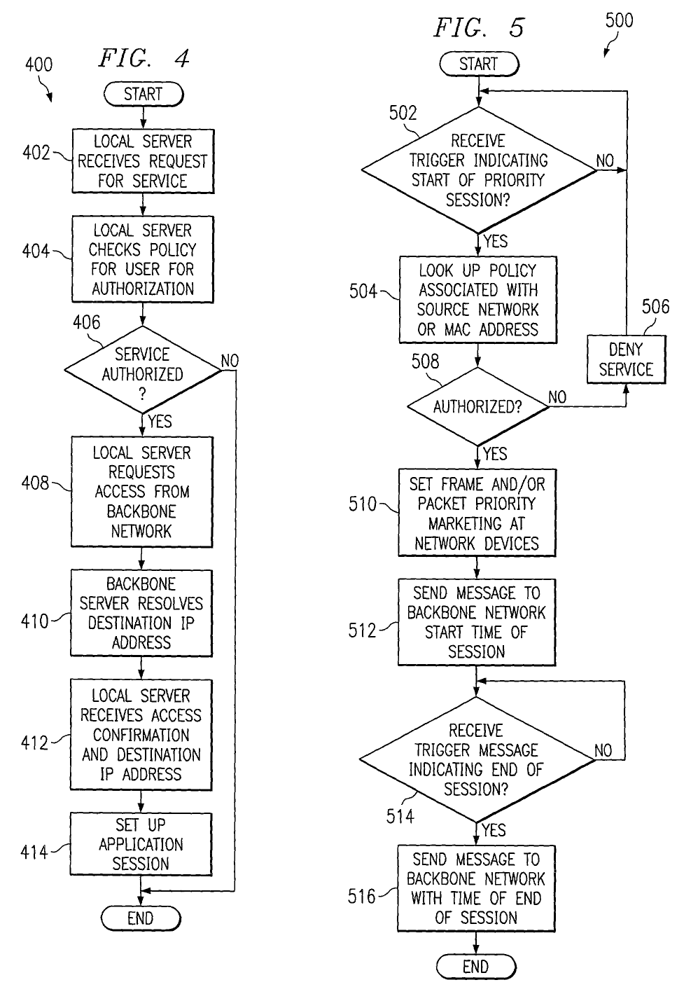

Process 400 of FIG. 4 illustrates a session set up process. At step 402, the local server receives a request for service and checks, at step 404, local policy for user authorization. The request for service might have been passed from gatekeeper 206 if, for example, it was a request for a connection outside of its domain. At decision step 406, if service is not authorized, the process ends. Otherwise, the local server requests at step 408 of network server 120 access from backbone network 100. If necessary, the network server resolves the destination IP address at step 410, based on the public address of the destination host provided by the local server during the request, and returns it at step 412. At step 414, session set up takes place according to H.323, SIP or other applicable protocol. The network server, with the assistance of the local server if necessary, mediates the set up with the application requesting service.

Process 500 illustrates detection, classification and marking of data flows for priority of service. At step 502, the local server waits to receive a signal that a trap, in particular an RMON trap, on a managed network device has been triggered. The trap triggers on fields in packet headers that are specific to the priority streams to be identified, creating an exception that is reported. If a trap is triggered and reported, information such as the source MAC and network address and type of application can be reported. In step 506, the local server looks up the policy associated with the local network and/or MAC address. It may also undertake the authorization part of process 400 of FIG. 4. If it is not authorized at step 508, service is denied for that address at step 506. Otherwise, based on the type of stream reported by the network nodes, the stream is classified and appropriate network elements or nodes, preferably the one closest to the source host, are instructed by the local server at step 510 to set priority codes on each packet and/or media frame for the flow. The local server also reports to network server 120 the start time of the session at step 512. As indicated by decision step 514, when a trap reports detecting a packet indicating an end of session, a message is sent to the network server at step 516 with the end time of the session.

The forgoing description is a representative example of a QoS packet network in which the invention may be used. Explaining the invention in reference to this network is not intended to limit its scope, as the illustrated network can be extensively modified without departing from its scope.

What is claimed is:

1. A method for providing differentiated quality of service communication services, comprising:
receiving from a customer's network for transmission over a backbone packet network a packet flow for a communications session, the packet flow including packets marked by customer's network prior to routing to the backbone packet network, the packets being marked with a quality of service indicator corresponding to one of a plurality of predetermined service levels; and
transmitting the packet flow on the backbone packet network according to the one of a plurality of predetermined service levels.

2. The method of claim 1, further comprising:
receiving from a server on the customer's network information on the length of the communications session; and
charging for transmission of the packet flow over the backbone packet network based at least in part on the length of the communications session.

3. A method for providing differentiated quality of service communication services between a customer's network and a backbone packet network, comprising:
detecting on a local or wide area network a packet flow of a communications session destined for another communications network and to be transmitted over a backbone packet network;
assigning one of a plurality of predetermined service levels to the communications session; and
marking packets in the packet flow with a quality of service indicator corresponding to the one of the plurality of predetermined service levels prior to routing the packets to the backbone packet network.

4. A communications network comprising:
a backbone packet network connected to a customer's packet network;
a network server for facilitating use of the backbone packet network; and
a local server on the customer's network in communication with the network server for determining which of a plurality of service levels in packet flow originating on the customer network and transmitted over the backbone packet network is to receive on at least the backbone packet network.
